(19) United States
(12) Patent Application Publication
(10) Pub. No.: US 2020/0061908 A1
(43) Pub. Date: Feb. 27, 2020

(54) 3D ADDITIVE MANUFACTURING DEVICE AND ADDITIVE MANUFACTURING METHOD

(71) Applicant: ADVANTEST CORPORATION, Tokyo (JP)

(72) Inventors: Akio YAMADA, Saitama (JP); Shinji SUGATANI, Saitama (JP); Minoru SOMA, Saitama (JP)

(21) Appl. No.: 16/498,398

(22) PCT Filed: Apr. 11, 2017
(86) PCT No.: PCT/JP2017/014807

§ 371 Date: Sep. 27, 2019

(51) Int. Cl. B29C 64/153; B29C 64/268; B29C 64/393; B29C 64/205

(52) U.S. Cl. CPC B29C 64/153; B29C 64/268; B33Y 10/00; B29C 64/205; B29C 64/393

(57) ABSTRACT

A 3D additive manufacturing device 100 is provided, including a determination unit 116 that receives modeling data relating to a shape of a section of a 3D structure 66 and determines data of irradiation positions, beam shapes, and irradiation times of a first beam and a second beam along a continuous curve, a storage unit 118 that stores the data determined by the determination unit 116, a deflection control unit 150 that outputs the irradiation position data to a deflector 50 at a timing generated based on the irradiation time data, and a deformation element control unit 130 that outputs the beam shape data to a deformation element 30. Thus, the 3D additive manufacturing device 100 forms a 3D structure by laminating sectional layers constituted by curves in a manner of melting/solidifying a powder layer while performing irradiation with the first beam and the second beam along the continuous curve.

### BACKGROUND

### 1. Technical Field

The present invention relates to a 3D additive manufacturing device and an additive manufacturing method.

### 2. Related Art

There is a 3D additive manufacturing device in which a 3D structure is formed in a manner that a predetermined area of the surface of a powder layer made of a metal material or the like is irradiated with an electron beam to form a sectional layer in which a portion of the powder layer is melted and solidified, and such sectional layers are laminated. For example, Patent Literatures 1 and 2 disclose a 3D additive manufacturing device and an additive manufacturing method using the same.

### CITATION LIST

### Patent Literature

Patent Literature 1: U.S. Pat. No. 7,454,262
Patent Literature 2: JP 2015-193866 A

In the conventional 3D additive manufacturing device disclosed in Patent Literature 1, the surface of the powder layer is divided into small sections, and each small section is irradiated with the electron beam. In the 3D additive manufacturing device disclosed in Patent Literature 2, irradiation with the electron beam is performed by linearly scanning the electron beam on the surface of the powder layer. In this manner, the surface of the powder layer is partially melted and solidified, and the melted and solidified portions are connected to form the entirety of the sectional layer.

However, in the conventional 3D additive manufacturing device, it is difficult to accurately form a shaped object having a smooth surface.

### SUMMARY

According to a first aspect of the present invention, there is provided a 3D additive manufacturing device that forms a 3D structure by laminating sectional layers obtained by melting and solidifying a powder layer. The 3D additive manufacturing device includes an electron beam column that outputs a first beam and a second beam for irradiation in parallel with the first beam, a forming unit that accommodates raw material powder irradiated with the first beam, and a controller that controls the electron beam column. The controller includes a determination unit that sets a plurality of irradiation positions of the first beam and the second beam along a plurality of loop-like lines representing a path of the electron beam with which the sectional layer is irradiated, and determines an irradiation time at each of the irradiation positions, a storage unit that stores data of the irradiation position and the irradiation time determined by the determination unit, and a timing generation unit that generates a timing for reading irradiation position data from the storage unit in accordance with the irradiation time and outputting the irradiation position data to the electron beam column.

According to a second aspect of the present invention, there is provided an additive manufacturing method performed in the 3D additive manufacturing device. The additive manufacturing method includes a step of setting a plurality of irradiation positions of the first beam and the second beam along a plurality of loop-like lines representing a path of the electron beam with which the sectional layer is irradiated, and determining an irradiation time at each of the irradiation positions, in the controller, a step of outputting data of the irradiation position to the electron beam column and performing irradiation with the electron beam, at a timing generated based on the irradiation time by the controller, and a step of brining the irradiation position of the electron beam back to a predetermined position on a surface of the powder layer every time irradiation with the electron beam along each of the plurality of loop-like lines is completed.

Thus, a 3D additive manufacturing device and an additive manufacturing method, for forming a section of a 3D structure, which is constituted by curves, are provided.

The above summary of the invention does not enumerate all the features necessary for the present invention. Subcombinations of the feature groups can also be inventions.

### BRIEF DESCRIPTION OF THE DRAWINGS

FIG. 1 illustrates a configuration example of a 3D additive manufacturing device 100.

FIG. 2 illustrates an example of a 3D structure 66 to be formed by the 3D additive manufacturing device 100 (a), and illustrates an example of a shape of a section of the 3D structure 66 in a cut surface β (b).

FIG. 3 illustrates an example of modeling data corresponding to the shape of the section of the 3D structure 66.

FIG. 4 illustrates an example of a continuous curve e constituting the modeling data.

FIG. 5 illustrates a determination example of an irradiation position along the continuous curve e.

FIG. 6 illustrates an example in which a surface 63 of a powder layer 62 is irradiated with a first beam and a second beam along the continuous curve e.

FIG. 7 illustrates an example of data of irradiation positions, beam shapes, and irradiation times of the first beam and the second beam, which are determined by the determination unit 116 for the continuous curve e constituting the modeling data.

FIG. 8 illustrates a configuration example of a deflection control unit 150.

FIG. 9 is a geometrical optical diagram of an electron beam output from an electron source 20 having an anisotropic electron emission surface.

FIG. 10 illustrates an example of an electron beam shape for irradiating the surface 63 of the powder layer 62.

FIG. 11 illustrates a configuration example of a deformation element control unit 130.

FIG. 12 illustrates an example of an operation flow illustrating an additive manufacturing operation of the 3D additive manufacturing device 100.

### DESCRIPTION OF EXEMPLARY EMBODIMENTS

Hereinafter, the present invention will be described with embodiments of the invention, but the following embodiments do not limit the invention according to the claims. All combinations of features described in the embodiments are not essential to the solution of the invention.

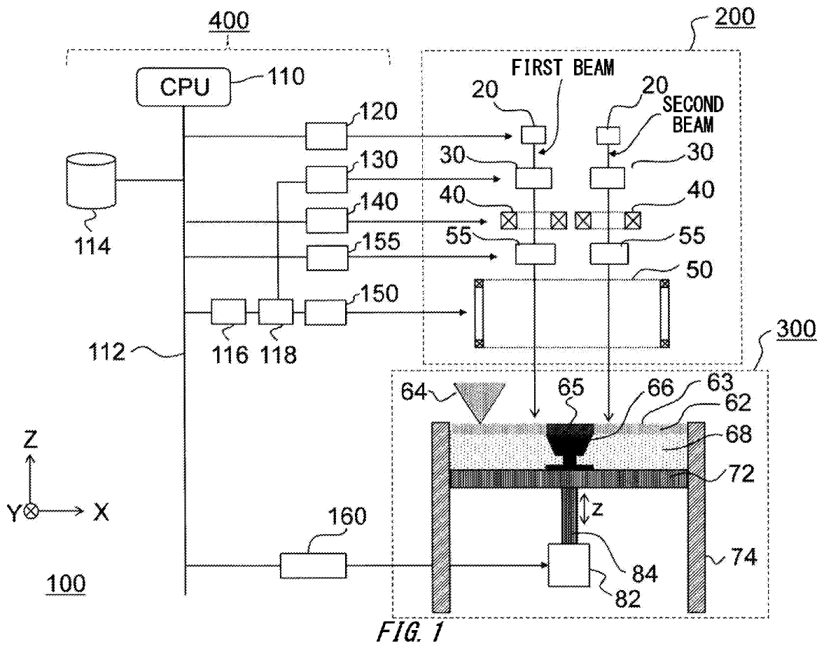

FIG. 1 illustrates a configuration example of a 3D additive manufacturing device 100 according to an embodiment. The 3D additive manufacturing device 100 includes an electron beam column 200, a forming unit 300, and a controller 400.

An electron beam is output from the electron beam column 200 of the 3D additive manufacturing device 100. The electron beam is controlled by a control signal of the controller 400, and is applied. A forming container is installed in the forming unit 300, and a powder layer 62 made of powder of, for example, a metal material is accommodated in the forming container. The powder layer 62 is irradiated with an electron beam to melt and solidify a portion of the powder layer 62, and thereby forms a sectional layer 65. A 3D structure 66 is formed by laminating such sectional layers 65.

The electron beam column 200 includes a plurality of electron sources 20 that outputs an electron beam. The electron source 20 generates electrons by an action of heat or an electric field. The electrons generated by the electron source 20 are accelerated in a −Z direction at a predetermined acceleration voltage (60 KV as an example), and are output in a form of an electron beam. In the example illustrated in FIG. 1, an example in which two electron sources 20 are provided in the electron beam column 200, and the electron sources output a first beam and a second beam, respectively, is illustrated.

The first beam is used for melting and solidifying the powder layer 62. The second beam is used for auxiliary irradiation of the powder layer 62. The auxiliary irradiation is irradiation performed for heating the surrounding powder layer 62 to a temperature below the melting point of the surrounding powder layer 62, when the powder layer 62 is melted and solidified. In the embodiment, the number of electron sources 20 is not limited to two, and may be three or more.

Hereinafter, in order to simplify the description, a case where the number of electron sources 20 and the number of electron beams are two will be described as an example.

A distance between the beams in an in-XY plane direction of the first beam and the second beam is, for example, 60 mm or less, for example, about 30 mm. The acceleration voltages applied to the two electron sources 20 are both 60 KV, for example. Because of the equal acceleration voltage, the two electron sources 20 can be arranged in proximity at a distance of about 30 mm.

Each electron source 20 includes, for example, a thermionic emission type cathode unit that emits electrons from the tip of an electrode heated to a high temperature.

Both the tips of the cathode electrodes of the electron sources 20 that output the first beam and the second beam may have anisotropic electron emission surfaces that have different widths in a longitudinal direction and in a lateral direction orthogonal to the longitudinal direction. The electron beam emitted from the anisotropic electron emission surface has an anisotropic sectional shape reflecting the electron emission surface.

Instead of this, the cathode unit of any one of the two electron sources 20 may be an electrode having an electron emission surface of an isotropic shape such as, for example, a circle or a square. The electron beam emitted from the isotropically shaped electron emission surface has an isotropic sectional shape.

In the embodiment, an example in which two electron sources 20 both emit electron beams having an anisotropic sectional shape from an anisotropic electron emission surface will be described.

The cathode unit having an anisotropic electron emission surface may be formed, for example, by forming crystal of lanthanum hexaboride (LaB6) into a columnar shape, and processing the end portion of the column into a wedge shape.

In embodiment, a lateral direction of the anisotropic electron emission surface is set as an X-axis direction, the longitudinal direction is set as a Y-axis direction, and an emission direction of the electron beam is set as a Z-axis direction. In addition, it is assumed that the length in the lateral direction of the electron emission surface is, for example, 300 μm or less, and the length in the longitudinal direction is, for example, 500 μm or more.

A deformation element 30 deforms the sectional shape of the electron beam output from the electron source 20. In the example illustrated in FIG. 1, sectional shapes of the first beam and the second beam output from the electron source 20 having an anisotropic electron emission surface are deformed by the deformation element 30 through which each beam passes.

The deformation element 30 is, for example, an element in which multiple stages of multipole elements are arranged in a traveling direction of the electron beam passing in the Z-axis direction. The center of symmetry of an electric field (or magnetic field) formed by the multipole element in the in-XY plane is located near the center of a passage path of the electron beam.

The multipole element is, for example, an electrostatic quadrupole element. The electrostatic quadrupole element includes two electrodes that generate an electric field facing in the X-axis direction and two electrodes generating an electric field facing in the Y-axis direction, with the Z axis through which the electron beam passes interposed therebetween.

Instead of this, the multipole element may be an electromagnetic quadrupole element. The electromagnetic quadrupole element may include two electromagnetic coils that generate a magnetic field facing in a (X+Y) direction, and two electromagnetic coils that generate a magnetic field facing in a (X−Y) direction, with the Z axis through which the electron beam passes interposed therebetween.

An electromagnetic lens 40 converges the first beam and the second beam on the surface 63 of the powder layer 62. The electromagnetic lens 40 is constituted by a coil wound around a lens axis, and a magnetic body (yoke) surrounding the coil and having a gap axially symmetrical with respect to the lens axis. A magnetic flux is emitted from the gap of the magnetic body of the electromagnetic lens 40, and thereby a local magnetic field directed in a lens axis direction on the lens axis is generated inside the electromagnetic lens 40.

The lens magnetic field excited by the electromagnetic lens 40 converges the electron beam passing along a path substantially coinciding with the lens axis. The first beam and the second beam are individually converged by the electromagnetic lens 40 through which each beam passes along the lens axis.

A deflector 50 adjusts irradiation positions of the first beam and the second beam on the surface 63 of the powder layer 62 installed in the forming unit 300 by deflecting the first beam and the second beam. The deflector 50 may be a common deflector that simultaneously deflects a plurality of electron beams. Since the second beam is for performing auxiliary irradiation, and the accuracy in irradiation position is not required, it is sufficient to use a deflector common to the first beam.

The common deflector 50 that simultaneously deflects the plurality of electron beams is desirably an electromagnetic deflector 50. In order to simultaneously deflect a plurality of electron beams, the deflector 50 preferably generates deflection fields in the directions having substantially the same intensity and substantially the same direction in the in-XY plane direction, along the Z-axis direction which is the passage path of each electron beam. The electromagnetic deflector 50 can easily generate such a magnetic field by winding a deflection coil so as to surround all passage paths of the plurality of electron beams.

In addition, the electromagnetic deflector 50 may set the number of turns of the deflection coil and the value of a current flowing in the deflection coil such that a deflectable range of the first beam and the second beam is 150 mm or more. The deflectable range is a distance between the irradiation positions of the electron beam on the surface 63 of the powder layer 62 when the electron beam is not deflected and when the electron beam is deflected the largest, respectively.

The deflectable range (150 mm in this case) of the first and second beams is wider than an inter-beam distance (30 mm in this case) between the first beam and the second beam. Regarding the first beam and the second beam, irradiation with each of the electron beams in a common portion (overlapping portion) of the deflection range can be performed.

The electron beam column 200 illustrated in FIG. 1 may further include a sub-deflector 55. The sub-deflector 55 is an electrostatic deflector that deflects the traveling direction of the first beam and/or the second beam from the direction of the beam axis parallel to the Z axis.

The sub-deflector 55 adjusts the distance between the relative irradiation positions of the first beam and the second beam on the surface 63 of the powder layer 62. That is, for example, the sub-deflector 55 deflects and adjusts the irradiation position of the second beam, for example, from a state where substantially the same position as the irradiation position of the first beam is irradiated, to a state where a position spaced by 30 mm being the beam distance between the first beam and the second beam is irradiated.

That is, the electron beam column 200 includes the deflector 50 that is common between the first beam and the second beam and deflects both the beams within an irradiable range of 150 mm or more, and the sub-deflectors 55 which are provided individually for the first beam and the second beam and adjust the distance between the irradiation positions of both the beams within a range of about 30 mm.

The electron beam column 200 can arrange the first beam and the second beam to be close to each other in comparison to a case where deflectors having an irradiable range of 150 mm or more are individually provided for the first beam and the second beam. Thus, the size of the electron beam column 200 that outputs a plurality of electron beams is reduced.

The forming unit 300 having a configuration example illustrated in FIG. 1 holds a powder sample 68 supplied from a powder supply unit 64, in the forming container. The forming container has a bottom portion 72 and a side wall portion 74. The powder sample 68 supplied from the powder supply unit 64 is flattened inside the side wall portion 74 by a grinding operation of the powder supply unit 64 to form a powder layer 62 substantially parallel to the upper surface of the bottom portion 72. A surface which is the upper surface of the powder layer 62 and is irradiated with the electron beam is referred to as the surface 63.

The height of the bottom portion 72 is movable in the Z-axis direction by a driving unit 82 and a drive rod 84. The height of the bottom portion 72 in the Z-axis direction is set to be substantially the same height when the surface 63 of the powder layer 62 covering the 3D structure 66 is irradiated with the electron beam.

A portion of the powder layer 62, which is melted and solidified by irradiation with the electron beam, forms a sectional layer 65 and is laminated on the 3D structure 66. Other portions of the powder layer 62 except the laminated sectional layer 65 are accumulated as the powder sample 68 around the 3D structure 66.

An internal space of the electron beam column 200, through which the electron beam passes, and a space in the vicinity of the surface 63 of the powder layer 62 irradiated with the electron beam are evacuated to a predetermined degree of vacuum. This is because the electron beam collides with gas molecules in the atmosphere and thus loses energy. The 3D additive manufacturing device 100 includes an exhaust unit (not illustrated) for exhausting the passage path of the electron beam.

A CPU 110 included in the controller 400 of the 3D additive manufacturing device 100 controls the overall operation of the 3D additive manufacturing device 100. The CPU 110 may be a computer, a work station or the like having a function of an input terminal for inputting an operation instruction from a user.

The CPU 110 is connected to a determination unit 116 and a storage unit 118 via a bus 112. A deformation element control unit 130 and a deflection control unit 150 receive a control signal from the CPU 110 via the storage unit 118.

The CPU 110 is connected to an electron source control unit 120, a lens control unit 140, a sub-deflection control unit 155, and a height control unit 160 via the bus 112.

The control units included in the controller 400 individually control components of the electron beam column 200 and the forming unit 300 in accordance with a control signal and the like received from CPU 110. Each of the control units is connected to a modeling data accumulation unit 114 via the bus 112, and transmits and receives modeling data accumulated in the modeling data accumulation unit 114.

The modeling data is data relating to the shape of a section obtained when the 3D structure 66 is cut in a plane orthogonal to a height direction in accordance with the height of the structure 66 to be formed by the 3D additive manufacturing device 100. Here, the height direction of the 3D structure 66 corresponds to the Z-axis direction of FIG. 1. The plane orthogonal to the height direction corresponds to a plane parallel to the XY plane of FIG. 1.

The determination unit 116 receives the modeling data accumulated in the modeling data accumulation unit 114, and determines control data for controlling the electron beam column. The control data includes data of the irradiation positions of the first beam and the second beam on the surface 63 of the powder layer 62, and data of beam shapes and irradiation times of the first beam and the second beam at the respective irradiation positions.

The storage unit 118 stores the data of the irradiation positions, the beam shapes, and the irradiation times of the first beam and the second beam, which have been determined by the determination unit 116, and outputs the data to the deformation element control unit 130 and the deflection control unit 150. An embodiment example of the configuration and the operation of the determination unit 116 and the storage unit 118 will be described later.

The electron source control unit 120 receives a command from the CPU 110 and individually controls the plurality of electron sources 20 that outputs the first beam and the second beam. The electron source control unit 120 applies an acceleration voltage of the electron beam to the electron source 20. The electron source control unit 120 outputs a heating current of a heater for generating, for example, thermions in the electron source 20. The electron source control unit 120 outputs a control voltage of the electron beam to the electron source 20.

The deformation element control unit 130 individually controls the plurality of deformation elements 30 that deforms the sectional shapes of the first beam and the second beam. The deformation element control unit 130 receives beam shape data stored in the storage unit 118 and controls the deformation element 30 for each of the first beam and the second beam.

The deformation element control unit 130 outputs voltages to, for example, the two electrodes of the electrostatic quadrupole element in the deformation element 30, which face each other in the X-axis direction and the two electrodes thereof facing each other in the Y-axis direction, and thus generates an electric field for setting the sectional shapes of the first beam and the second beam.

The lens control unit 140 receives a command of the CPU 110 and individually controls a plurality of electromagnetic lenses 40 that converges the first beam and the second beam. The lens control unit 140 outputs a current to flow in a coil unit of the electromagnetic lens 40. The lens control unit 140 sets the lens intensity of the electromagnetic lens by setting the magnitude of an output current to be supplied to the coil unit.

The deflection control unit 150 controls the deflector 50 to adjust the irradiation positions of the first beam and the second beam within a deflectable range wider than the inter-beam distance between the first beam and the second beam.

For example, the deflection control unit 150 outputs a current to two sets of deflection coils related to deflection of the electromagnetic deflector 50 in the X-axis direction and Y-axis direction, and thus generates a deflection magnetic field for adjusting the irradiation position of the electron beam on the surface 63 of the powder layer 62. The deflection control unit 150 receives irradiation position data stored in the storage unit 118 and controls the deflector 50.

The sub-deflection control unit 155 receives a command from the CPU 110 and controls the sub-deflector 55. The sub-deflection control unit 155 applies a voltage to the electrostatic deflector constituting the sub-deflector 55 to set the distance between the relative irradiation positions of the first beam and the second beam on the surface 63 of the powder layer 62.

The height control unit 160 receives a command from the CPU 110 and controls the driving unit 82. The height control unit 160 controls the driving unit 82 to set the length of the drive rod 84 in the Z-axis direction and the height of the bottom portion 72.

The height control unit 160 sets the height of the bottom portion 72 each time a new powder layer 62 is supplied after the powder layer 62 is melted and solidified to form the sectional layer 65. The height control unit 160 lowers the bottom portion 72 by the thickness of the new powder layer 62 and thus maintains the height of a beam irradiation surface which is the surface 63 of the new powder layer 62 covering the 3D structure 66 to be substantially constant. This is because the height of the 3D structure 66 in the Z-axis direction increases as the sectional layer 65 is laminated.

An example of the related components of the 3D additive manufacturing device 100 in the embodiment will be described in accordance with a flow of the control data from the modeling data accumulation unit 114 to the deflection control unit 150 and the deformation element control unit 130 via the determination unit 116 and the storage unit 118.

The control data is used to control the first beam to perform electron beam irradiation for melting and solidifying a portion of the powder layer 62. The control data is used to control the second beam to assist irradiation of the surface 63 of the powder layer 62.

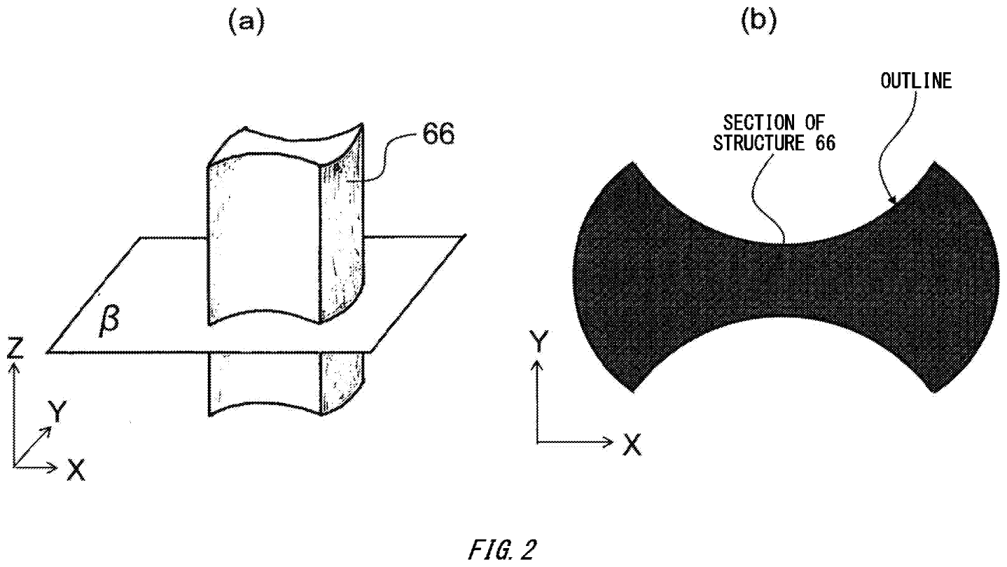

(a) of FIG. 2 illustrates an example of the 3D structure 66 to be formed by the 3D additive manufacturing device 100. A plane β parallel to the XY plane is a plane orthogonal to the height direction of the 3D structure 66, and represents a cut surface obtained by cutting the 3D structure 66 at a certain height.

(b) of FIG. 2 illustrates a shape of a section of the 3D structure 66 in a cut surface β. The section of the 3D structure is generally configured by one or a plurality of regions corresponding to an area of the powder layer 62, which is to be melted and solidified. In the example illustrated in (b) of FIG. 2, the section of the structure 66 is established from one region surrounded by an outline. The shape of the section is characterized by being configured by a curve as illustrated in the example of the outline, as illustrated in (b) of FIG. 2.

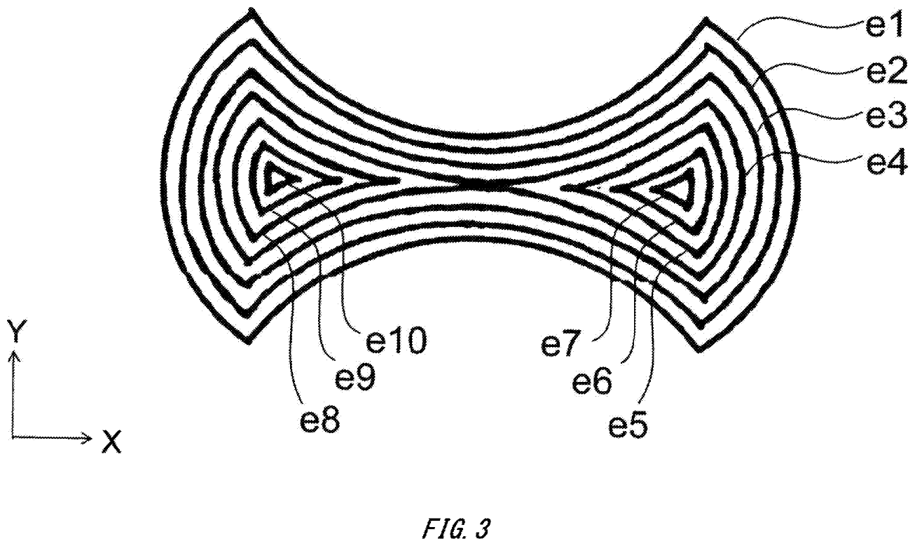

FIG. 3 illustrates an example of modeling data corresponding to the shape of the section of the 3D structure 66 illustrated in (b) of FIG. 2. In response to the sectional shape being configured by a curve, the modeling data is configured by a plurality of continuous loop-like curves (including broken lines) representing paths on which the irradiation with the electron beam is to be performed on the surface 63 of the powder layer 62, in order to melt and solidify the powder layer 62.

In the example of the modeling data of FIG. 3, a case where the loop-like curve is a closed line in which a start point coincides with an end point is illustrated. However, the modeling data is not limited to such a case. The modeling data may correspond to a case where the start point of the curve does not coincide with the end point thereof, that is, may be, for example, a spiral curve. The modeling data may be configured by a loop-like line representing a path, on which the section of the structure 66 can be irradiated with the electron beam without leakage, in order to melt and solidify the powder layer 62.

In the example of FIG. 3, the modeling data includes a continuous curve e1 corresponding to the outer circumference of the section and a plurality of continuous curves e2, e3, . . . , and e10 which is arranged inside the curve e1 and is disposed at an equal distance. The modeling data is created in advance for each cut surface obtained by cutting the 3D structure 66 at a predetermined height, based on design data relating to the shape of the 3D structure 66. The modeling data is accumulated in the modeling data accumulation unit 114.

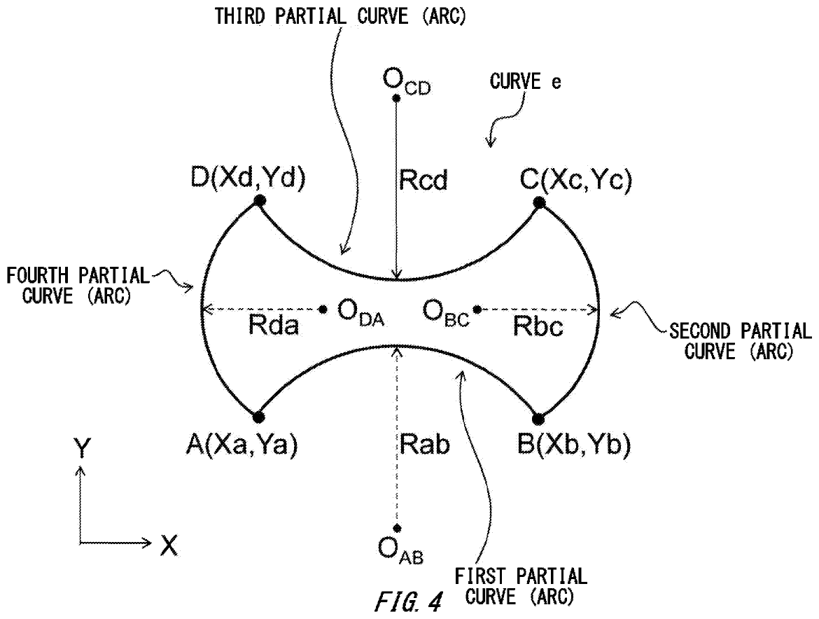

FIG. 4 illustrates an example of the continuous curve e. The continuous curve e corresponds to any of the curves e1, e2, e3, . . . , and e10 constituting the modeling data illustrated in the example in FIG. 3.

The continuous curve e is configured by a plurality of partial curves if divided into appropriate lengths. In the embodiment, each partial curve is approximate to an arc (which may be a line segment) having a predetermined curvature (curvature radius) passing through both ends of the partial curve. In the example illustrated in FIG. 4, the continuous curve e is a continuous curve connecting four partial curves approximate to arcs.

For example, the first partial curve of the curve e connects a point A having position coordinates (Xa, Ya) and a point B having position coordinates (Xb, Yb) to each other, and is approximate to an arc having a curvature radius Rab. The second partial curve connects the point B having the position coordinates (Xb, Yb) and a point C having position coordinates (Xc, Yc) to each other, and is approximate to an arc having a curvature radius Rbc.

The third partial curve connects the point C having the position coordinates (Xc, Yc) and a point D having position coordinates (Xd, Yd) to each other, and is approximate to an arc having a curvature radius Rcd. The fourth partial curve connects the point D having the position coordinates (Xd, Yd) and the point A having the position coordinates (Xa, Ya) to each other, and is approximate to an arc having a curvature radius Rda.

In the modeling data, the arcs which are approximate to the first partial curve and protrudes in a +Y-axis direction may be distinguished from the arcs which are approximate to the third partial curve and protrudes in a −Y-axis direction, by the signs of the curvature radii. Similarly, in the modeling data, the arcs which are approximate to the second partial curve and protrudes in a +X-axis direction can be distinguished from the arcs which are approximate to the fourth partial curve and protrudes in a −X-axis direction, by the signs of the curvature radii. Although not included in the example of FIG. 4, the modeling data may express a line segment connecting two points by designating a special value as the curvature radius.

Since the end point B of the first partial curve and the end point B of the second partial curve are common points, the end point C of the second partial curve and the end point C of the third partial curve are common points, the end point D of the third partial curve and the end point D of the fourth partial curve are common points, and the end point A of the fourth partial curve and the end point A of the first partial curve are common points, the modeling data illustrated in FIG. 4 expresses the continuous curve e closed as a whole.

FIGS. 3 and 4 illustrate the example of the modeling data constituting relatively simple curves corresponding to the shape of the section of the 3D structure 66, but the embodiment is not limited thereto. The modeling data of a practical 3D structure 66 may be configured by more complex curves, depending on the shape of the section. In order to form the section of the 3D structure 66, the modeling data may be configured by a curve representing an irradiation path of the electron beam on the surface 63 of the powder layer 62.

Even in such a case, the partial curve is approximate to an arc (which may include a straight line) if the continuous curve constituting the modeling data is divided into partial curves having an appropriate length. That is, the modeling data relating to the shape of the section of the 3D structure 66 is configured by a continuous curve in which a plurality of partial curves approximate to arcs are connected to each other.

Assuming that such modeling data is accumulated in the modeling data accumulation unit 114, an example of the determination unit 116, the storage unit 118, the deflection control unit 150, and the deformation element control unit 130 included in the controller 400 in FIG. 1 in the embodiment will be described.

The determination unit 116 receives an input of the modeling data relating to the shape of the section of the 3D structure 66, and determines data of the irradiation positions of the first beam and the second beam along the continuous curve on the surface 63 of the powder layer 62 and data of the beam shapes and the irradiation times of the first beam and the second beam at the corresponding irradiation position.

More specifically, the determination unit 116 receives an input of a partial curve approximate to an arc, and determines data of the irradiation positions, the beam shapes, and the irradiation times of the first beam and the second beam along this partial curve. Furthermore, the determination unit 116 determines data of the irradiation positions, the beam shapes, and the irradiation times of the first beam and the second beam for modeling data configured of one or a plurality of partial curves.

An operation in which the determination unit 116 determines data of the irradiation position along the partial curve will be described by using the first partial curve illustrated in FIG. 4 as an example. The first partial curve represents a partial curve which connects the point A having the position coordinates (Xa, Ya) and the point B having the position coordinates (Xb, Yb) to each other, and is approximate to an arc having a curvature radius Rab.

(1) First, the determination unit 116 determines the length Lab of the arc connecting the point A and the point B. That is, the length Lab of the arc which has the curvature radius Rab and is from the point A (Xa, Ya) to the point B (Xb, Yb) is obtained from the following Expression 1.

Lab=2Rab×arcsin((((Xa−Xb)2+(Ya−Yb)2)1/2)/2Rab) (Expression 1)

(2) Next, the determination unit 116 determines the number n of times of irradiation along the arc. The number n of times at which the distances between the irradiation positions along the arc do not exceed a predetermined distance δ, are close to a distance δ, and are equal to each other is obtained. Here, n can be obtained based on the following Expression 2 as an example.

n=[Lab/δ]+1 (Expression 2)

Here, [Lab/δ] is a Gaussian symbol giving the largest integer without exceeding Lab/δ.

Also, the distance δ may be predetermined depending on the beam size, or the beam shape, or the beam intensity of the electron beam used for irradiation along the partial curve.

(3) Then, the determination unit 116 determines the distance δab between the actual irradiation positions along the arc. For example, the distance δab between the irradiation positions can be obtained from the following Expression 3.

δab=Lab/n (Expression 3)

(4) The determination unit 116 determines irradiation position data (coordinate data of the irradiation position) corresponding to n irradiation positions A (=PA1), PA2, . . . , and PAn having an equal distance δab along the arc approximate to the first partial curve. The distance between the adjacent irradiation positions is dab.

The determination unit 116 also determines irradiation position data of the irradiation positions B (=PB1), PB2, . . . , and PBm having an equal distance δbc for the second partial curve. Further, the determination unit 116 also determines irradiation position data along the arc of the partial curve for the third partial curve and the fourth partial curve.

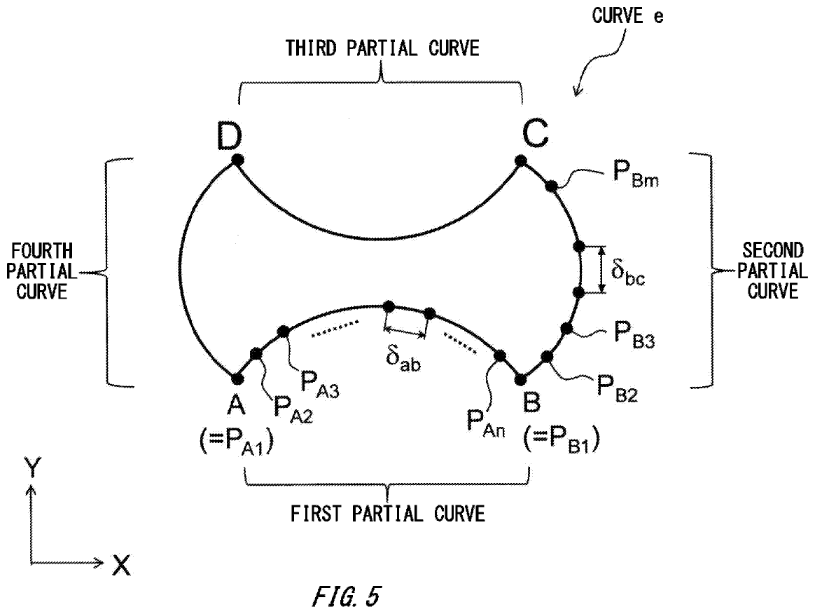

FIG. 5 illustrates irradiation positions P along a plurality of partial curves constituting the continuous curve e, which have been determined in the above-described manner. The determination unit 116 determines the irradiation position P and the corresponding irradiation position data for the plurality of partial curves constituting the continuous curve e in this manner. Furthermore, the determination unit 116 determines the irradiation position P and the corresponding irradiation position data for all the continuous curves constituting the modeling data.

The distances δab, δbc, δcd, and δda of the irradiation positions of the first partial curve, the second partial curve, the third partial curve, and the fourth partial curve are determined not to exceed the given distance δ, and such that all have the values close to the distance δ. That is, the distances δab, δbc, δcd, and δda are set to satisfy the following Expression 4. In this manner, the determination unit 116 determines the irradiation positions P arranged at substantially equal distances along the continuous curve e.

δab˜δbc˜δcd˜δda≤δ (Expression 4)

Thus, the irradiation positions P are arranged at substantially equal distances along the continuous curve e. When the irradiation positions P are irradiated with the first beam having the same beam shape or the same beam intensity along with the second beam, the temperature increase occurring in the powder layer 62 occurs substantially the same at any irradiation position P. That is, the electron beam raises the temperature of the powder layer 62 to be substantially uniform along the continuous curve e, and proceeds melting and solidification of the powder layer 62 to be substantially uniform along the continuous curve e.

The determination unit 116 may determine the distance δ between the irradiation positions in accordance with the beam shape or the beam intensity of the electron beam. This is because the distance between the irradiation positions causing the temperature of the powder layer 62 to uniformly rise along the continuous curve is determined depending on the beam shape or the beam intensity of the electron beam.

The irradiation position data determined by the determination unit 116 is stored in the storage unit 118. The irradiation position data stored in the storage unit 118 passes through the deflection control unit 150 and then is output to the deflector 50 which is common between the first beam and the second beam, at a predetermined timing.

The determination unit 116 sets the output timing based on the irradiation time. The irradiation time is an irradiation time of the first beam and the second beam for each irradiation position P, and is determined by the determination unit 116. The determination unit 116 determines the irradiation time based on conditions in which the powder layer 62 can be uniformly melted along the continuous curve constituting the modeling data.

The irradiation time of the electron beam for uniformly melting the powder layer 62 depends not only on the beam intensity of the electron beam or the material of the metal powder but also on the arrangement density of the irradiation positions on the surface 63 of the powder layer 62.

The determination unit 116 may determine irradiation time data which is substantially equal for irradiation positions arranged at equal distances on partial curves approximate to arcs having the same curvature radius. This is because the irradiation positions which are arranged at equal distances on the partial curves approximate to arcs having the same curvature radius are distributed at the substantially equal arrangement density on the surface 63 of the powder layer 62.

In addition, the determination unit 116 may determine different irradiation times for irradiation positions P arranged along partial curves approximate to arcs having different curvature radii. This is because, even though the irradiation positions P arranged along the partial curves approximate to the arcs having different curvature radii are arranged at equal distances along the partial curves, the arrangement density of the irradiation position P on the surface 63 on the powder layer 62 may be different.

For example, τab is determined as irradiation time data for irradiating each irradiation position P along the first partial curve approximate to the arc having a curvature radius Rab. The determination unit 116 determines τbc as irradiation time data for irradiating each irradiation position along the second partial curve approximate to the arc having a curvature radius Rbc.

Further, τcd is determined as irradiation time data for irradiating each irradiation position P along the third partial curve approximate to the arc having a curvature radius Rcd. The determination unit 116 determines τda as irradiation time data for irradiating each irradiation position P along the fourth partial curve approximate to the arc having a curvature radius Rda.

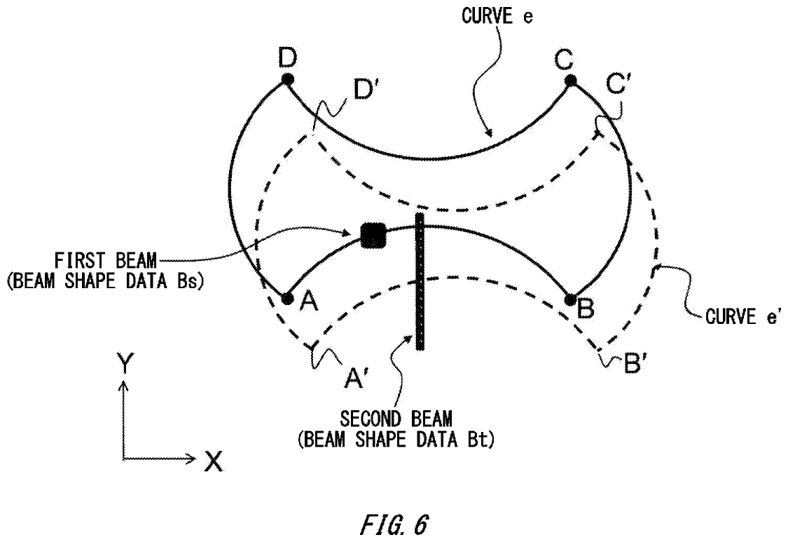

Furthermore, the determination unit 116 determines the beam shapes of the first beam and the second beam. FIG. 6 illustrates an example in which the surface 63 of the powder layer 62 is irradiated with the first beam and the second beam having the beam shapes determined by the determination unit 116, along the continuous curve illustrated in FIG. 4.

The determination unit 116 determines, for example, beam shape data Bs for forming a narrowed sectional shape in which the beam widths in a vertical direction (Y-axis direction) and the lateral direction (X-axis direction) are substantially equal to each other, as the beam shape of the first beam. The beam shape data Bs for forming an electron beam of a narrowed sectional shape is beam shape data of the first beam.

The surface 63 of the powder layer 62 is irradiated with the first beam having a narrowed sectional shape, along a solid curve e having end points A, B, C, and D. The first beam having a narrowed sectional shape raises the temperature of the powder layer 62 to a temperature equal to or higher than the melting point along the solid curve e, and thus melts and solidifies the powder layer 62.

Irradiation with the first beam having a narrowed sectional shape generates a sharp temperature difference between the portion of the powder layer 62 along the curve e and the other portions. Irradiation with the beam having a narrowed sectional shape causes the powder layer 62 along the curve e to be locally melted by the sharp temperature difference.

The irradiation time of the first beam having a narrowed sectional shape may be adjusted for each of the partial curves constituting the continuous curve e. This is because the determination unit 116 can set different irradiation time data τab, τbc, τcd, and τda for the partial curves, respectively. Partial curves approximate to arcs having different curvature radii may be irradiated with the first beam at different irradiation times.

The determination unit 116 determines, for example, beam shape data Bt for forming an expanded sectional shape in which the beam width in the vertical direction is longer than the beam width in the lateral direction, as the beam shape of the second beam. The beam shape data Bt for forming an electron beam of an expanded sectional shape is beam shape data of the second beam.

The surface 63 of the powder layer 62 is irradiated with the second beam having an expanded sectional shape, along a broken curve e′ having end points A′, B′, C′, and D′. Irradiation with the second beam having an expanded sectional shape is performed along the broken curve e′, and thereby the vicinity of the powder layer 62 portion melted by the first beam is additionally irradiated.

The first beam and the second beam are deflected by the common deflector 50 such that two points which are at an approximately equal distance on the curve e and the curve e′ are simultaneously irradiated. The second beam having an expanded sectional shape causes a position at a predetermined distance from the irradiation position of the first beam to be irradiated with the electron beam having a wider irradiation range.

That is, the vicinity of the irradiation position of the first beam is additionally irradiated with the second beam, and the second beam raises the temperature of the powder layer 62 in the vicinity of the irradiation position of the first beam. Since the temperature distribution of the powder layer 62 in the vicinity of the irradiation position of the first beam becomes uniform, the melted and solidified portion of the powder layer 62 has difficulty in receiving an influence of position shift caused by the temperature distribution in the powder layer 62.

At this time, the sub-deflector 55 (see FIG. 1) adjusts the distance between the irradiation positions of the first beam and the second beam. The sub-deflector 55 may adjust the inter-beam distance between the first beam and the second beam and thus set the temperature distribution of the powder layer 62 to become more uniform in the vicinity of the irradiation position of the first beam.

FIG. 6 illustrates an example in which the determination unit 116 determines uniform beam shapes at any position on the curve e, as the beam shapes of the first beam and the second beam. Instead of this, the determination unit 116 may determine different beam shapes for the first beam and the second beam, depending on the modeling data representing the irradiation path of the electron beam, for each of the partial curves constituting the continuous curve or for each of the irradiation positions arranged along the partial curve.

As described above, the 3D additive manufacturing device 100 including the determination unit 116 determines the irradiation positions, the beam shapes, and the irradiation times of the first beam and the second beam along one or a plurality of continuous curves (see FIG. 3) constituting the modeling data. The 3D additive manufacturing device 100 including the determination unit 116 forms the shape of the section of the 3D structure 66 based on the modeling data configured by the plurality of continuous curves.

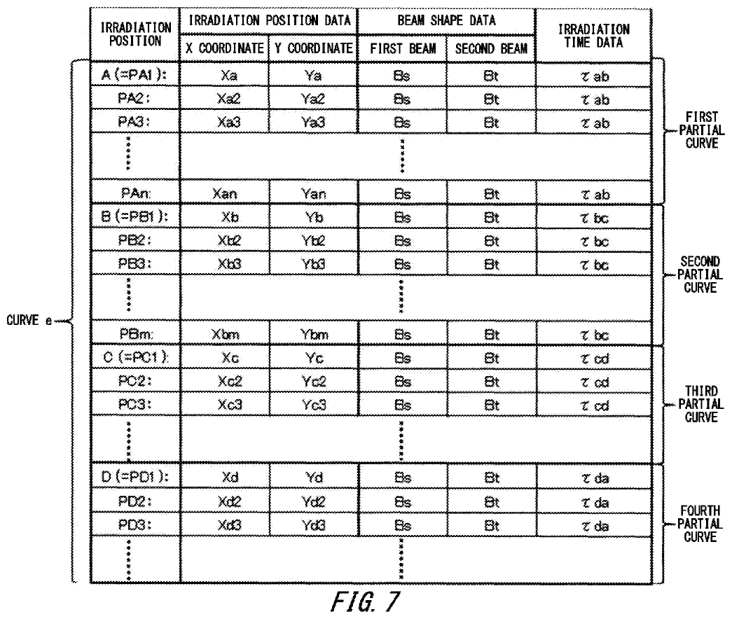

FIG. 7 illustrates an example of data of the irradiation positions, the beam shapes, and the irradiation times of the first beam and the second beam, which are determined by the determination unit 116 for the continuous curve e corresponding to the continuous curves e1, e2, e3, . . . , and e10 constituting the modeling data illustrated in FIG. 3.

The determination unit 116 receives modeling data representing the continuous curve e, and determines irradiation position data (Xa, Ya), (Xa2, Ya2), (Xa3, Ya3), . . . , and (Xan, Yan) respectively for the irradiation positions PA1, PA2, PA3, . . . , and PAn of the first partial curve, the shape data Bs of the first beam, the shape data Bt of the second beam, and irradiation time data τab.

In addition, the determination unit 116 receives the modeling data representing the continuous curve e, and determines irradiation position data (Xb, Yb), (Xb2, Yb2), (Xb3, Yb3), . . . , and (Xbm, Ybm) respectively for the irradiation positions PB1, PB2, PB3, . . . , and PBm of the second partial curve, the shape data Bs of the first beam, the shape data Bt of the second beam, and irradiation time data τbc.

Further, the determination unit 116 receives the modeling data representing the continuous curve e, and determines irradiation position data (Xc, Yc), (Xc2, Yc2), (Xc3, Yc3), . . . respectively for the irradiation positions PC1, PC2, PC3, . . . of the third partial curve, the shape data Bs of the first beam, the shape data Bt of the second beam, and irradiation time data τcd.

The determination unit 116 receives the modeling data representing the continuous curve e, and determines irradiation position data (Xd, Yd), (Xd2, Yd2), (Xd3, Yd3), . . . respectively for the irradiation positions PD1, PD2, PD3, . . . of the fourth partial curve, the shape data Bs of the first beam, the shape data Bt of the second beam, and irradiation time data τda.

FIG. 7 illustrates an example in which the first beam and the second beam are determined to have the predetermined shape data Bs and Bt for all partial curves constituting the continuous curve e and all irradiation positions. Instead of this, the first beam and the second beam may be determined to have different shape data for each of the partial curves constituting the continuous curve or for each of the irradiation positions arranged on the partial curve.

The storage unit 118 stores the data of the irradiation positions, the beam shapes, and the irradiation times of the first beam and the second beam, which have been determined by the determination unit 116. The storage unit 118 may store data of the irradiation positions, the beam shapes, and the irradiation times of the first beam and the second beam, which have been determined by the determination unit 116, in order of the irradiation position being arranged along the continuous curve e.

For example, the storage unit 118 stores data for the irradiation positions PA1, PA2, PA3, . . . , and PAn along the first partial curve in this order, and then stores the data for the irradiation positions PB1, PB2, PB3, . . . , and PBm along the second partial curve in this order.

Then, the storage unit 118 stores data for the irradiation positions PC1, PC2, PC3, . . . along the third partial curve in this order, and then stores the irradiation positions PD1, PD2, PD3, . . . along the fourth partial curve in this order.

By storing the data in this manner, the storage unit 118 can output the data of the irradiation positions, the beam shapes, and the irradiation times of the first beam and the second beam such that the irradiation position of the electron beam moves counterclockwise along the continuous curve e if the storage unit 118 outputs the data of the irradiation positions, the beam shapes, and the irradiation times of the first beam and the second beam in the same order as the order of such data being stored.

In addition, the storage unit 118 can output the data of the irradiation positions, the beam shapes, and the irradiation times of the first beam and the second beam such that the irradiation position of the electron beam moves clockwise along the continuous curve e if the storage unit 118 reads the data of the irradiation positions, the beam shapes, and the irradiation times of the first beam and the second beam in the reverse order to the order of such data being stored.

The storage unit 118 controls a storing order and an outputting order of the data of the irradiation positions, the beam shapes, and the irradiation times of the first beam and the second beam, so as to set a direction in which melting and solidification proceeds in the powder layer 62 to proceed in a predetermined direction along the continuous curve. Thus, the regularity relating to generation of heat and heat transfer in the powder layer 62 is improved, and the 3D additive manufacturing device 100 more easily controls the progress of melting and solidification in the powder layer 62.

In addition, the storage unit 118 may store the data of the irradiation positions, the beam shapes, and the irradiation times of the first beam and the second beam, which corresponds to the plurality of continuous curves e1, e2, e9, and e10 constituting the modeling data in FIG. 3, in this order, that is, in order of the size of an area surrounded by each of the curves.

The storage unit 118 may store the data of the irradiation positions, the beam shapes, and the irradiation times of the first beam and the second beam in order of the outermost curve e1 surrounding the largest area on the surface 63 of the powder layer 62, one inner curve e2, and more one inner curve e3,

The storage unit 118 may output the data of the irradiation positions, the beam shapes, and the irradiation times of the first beam and the second beam in the same order as the order of being stored in the storage unit 118, and thereby may melt and solidify the powder layer 62 while changing the irradiation position of the electron beam from the continuous curve on a relative outside of the powder layer 62 to the continuous curve on a relative inside thereof.

Instead of this, the storage unit 118 may output the data of the irradiation positions, the beam shapes, and the irradiation times of the first beam and the second beam in the reverse order to the order of being stored in the storage unit 118, and thereby may melt and solidify the powder layer 62 while changing the irradiation position of the electron beam from the continuous curve on a relative inside of the powder layer 62 to the continuous curve on a relative outside thereof.

That is, the storage unit 118 controls the storing order and the outputting order of the data of the irradiation positions, the beam shapes, and the irradiation times of the first beam and the second beam, and thereby sets the direction in which melting and solidification proceed in the powder layer 62 to a direction from the periphery of the sectional layer 65 to the center or a direction from the center of the sectional layer 65 to the periphery. Thus, the regularity relating to generation of heat and heat transfer in the powder layer 62 is improved, and the 3D additive manufacturing device 100 more easily controls the progress of melting and solidification in the powder layer 62.

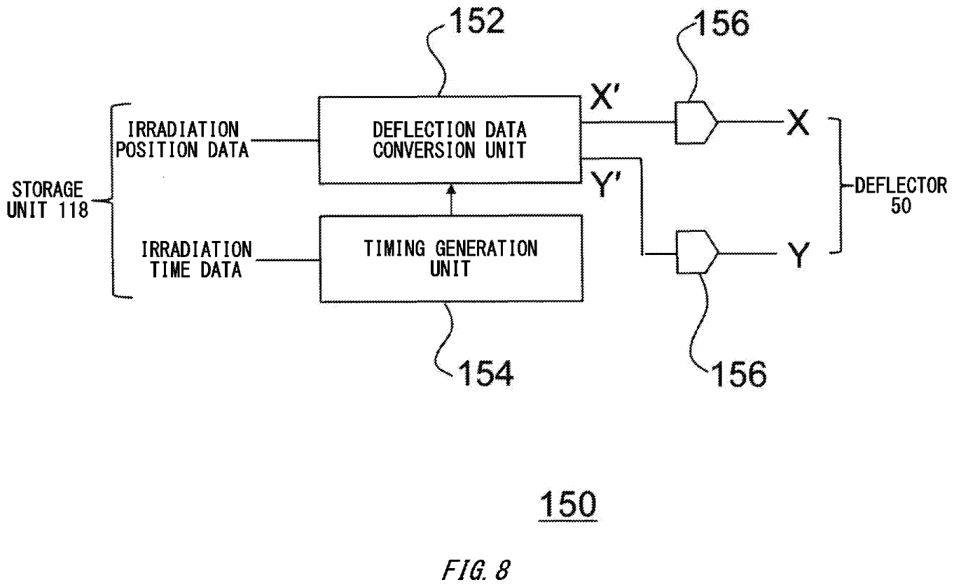

FIG. 8 illustrates a configuration example of the deflection control unit 150. A deflection data conversion unit 152 receives the irradiation position data (Xa, Ya), (Xa2, Ya2), (Xa3, Ya3), . . . and the like which have been determined by the determination unit 116 and stored in the storage unit 118, and performs coordinate transformation relating to deflection efficiency of the deflector 50. That is, the irradiation position data (X, Y) is converted by the following Expression 5 with deflection efficiency conversion coefficients Gx, Gy, Rx, Ry, Hx, Hy, Ox, and Oy of the deflector 50.

X′=Gx·X+Rx·Y+Hx·XY+Ox

Y′=Gy·Y+Ry·X+Hy·XY+Oy (Expression 5)

Here, the conversion coefficient is determined to actually deflect the beam to the irradiation position (X, Y) on the surface 63 of the powder layer 62 when the irradiation position data (X, Y) is designated. The deflection data conversion unit 152 outputs deflection data (X′, Y′) as a result of coordinate transformation to a deflection driving unit 156.

The deflection driving unit 156 performs digital/analog conversion on the deflection data (X′, Y′) subjected to coordinate transformation, and outputs a current proportional to the values of the X component and the Y component of the deflection data (X′, Y′) to deflection coils of the electromagnetic deflector 50 common between the first beam and the second beam, in the X direction and the Y direction. Thus, the deflector 50 irradiates a position indicated by the irradiation position data with the beam.

A timing generation unit 154 receives the irradiation time data τab, . . . , τbc, . . . which have been determined by the determination unit 116 and stored in the storage unit 118, from the storage unit 118. The timing generation unit 154 generates a timing at which the irradiation position data transformed to the deflection data (X′, Y′) is output to the deflection driving unit 156 and the deflector 50 in accordance with the irradiation time.

The timing generation unit 154 generates a timing at which the irradiation position data is output, so as to switch the irradiation position from the position indicated, for example, by the irradiation position data (Xa, Ya) to a position indicated by irradiation position data (Xa2, Ya2), after irradiation is performed during time indicated by the irradiation time data tab.

Then, the timing generation unit 154 generates a timing at which the irradiation position data is output, so as to switch the irradiation position from the position indicated by the irradiation position data (Xa2, Ya2) to irradiation position data (Xa3, Ya3), after irradiation is performed during time indicated by the irradiation time data τab.

Repeating the above description, the timing generation unit 154 performs control to irradiate each irradiation position for the time designated by the irradiation time data stored in the storage unit 118. The irradiation position is irradiated with the electron beam counterclockwise or clockwise along the continuous curve e constituting the modeling data, while the designated irradiation position is irradiated by the designated irradiation time.

Next, a configuration example and an operation example of the deformation element 30 and the deformation element control unit 130 that change the beam shapes of the first beam and the second beam based on beam shape data stored in the storage unit 118 will be described.

In the following descriptions, a case where the deformation element 30 is configured by an electrostatic quadrupole element including two electrodes generating an electric field facing in the X-axis direction and two electrodes generating an electric field facing in the Y-axis direction.

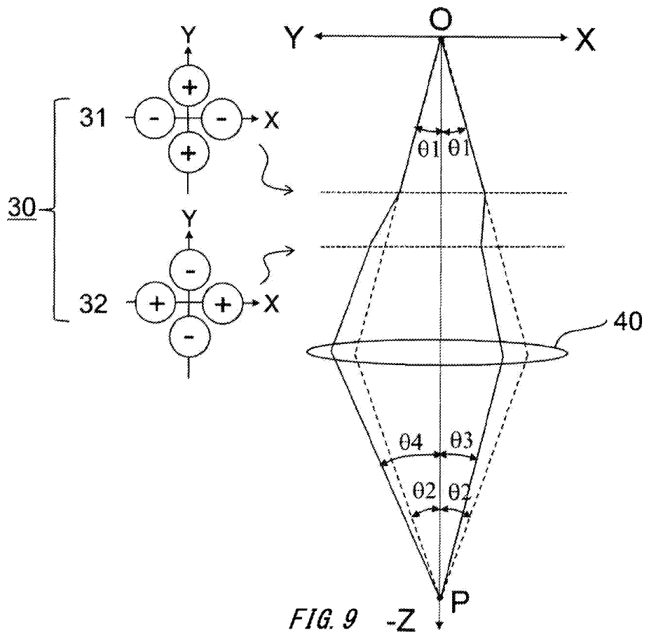

FIG. 9 is a geometrical optical diagram of the electron beam output from the electron source 20 having an anisotropic electron emission surface. The figure illustrated on the right side of the Z axis which extends in an up-and-down direction and is indicated at the substantially center in FIG. 9 illustrates a geometrical optical diagram of the electron beam in a plane (XZ plane) made by the Z-axis direction being the traveling direction of the electron beam and the X-axis direction being the lateral direction of the anisotropic electron emission surface. The figure illustrated on the left side of the Z axis illustrates a geometrical optical diagram of the electron beam in a plane (YZ plane) made by the Z-axis direction being the traveling direction of the electron beam and the Y-axis direction being the longitudinal direction of the anisotropic electron emission surface.

The electromagnetic lens 40, which is axially symmetrical with respect to the Z-axis direction, converges the electron beam passing along a path which substantially coincides with the Z-axis. The broken line in FIG. 9 indicates an imaging relationship of the electron beam by the electromagnetic lens 40 when the deformation element 30 is not driven. The electromagnetic lens 40 images an image on the electron emission surface having an anisotropic shape in which the lengths in the X-axis direction and the Y-axis direction are different from each other, on the surface 63 of the powder layer 62 at the same magnification in the XZ plane and the YZ plane.

That is, in the broken line in FIG. 9, when emission angles θ1 of the electron beam that emits a point O into the XZ plane and the YZ plane are equal to each other, convergence angles θ2 of the electron beam at a point P are equal to each other in the XZ plane and the YZ plane.

Next, a case of driving the deformation element 30 will be described. An example of the deformation element 30, in which electrostatic quadrupole elements 31 and 32 are arranged at two stages in the Z-axis direction will be described. Each of the electrostatic quadrupole elements 31 and 32 includes two electrodes generating an electric field facing in the X-axis direction and two electrodes generating an electric field facing in the Y-axis direction. The electrostatic quadrupole elements 31 and 32 are arranged such that the two sets of poles are aligned in the same directions as the longitudinal direction and the lateral direction of the electron emission surface of the electron source 20.

The electron beam passes through the centers of the four electrodes in the Z-axis direction. The positive (+) sign and the negative (−) sign described on the electrodes indicate the polarities of the voltage applied to each electrode. The electrostatic quadrupole elements 31 and 32 applies voltages having different polarities to the X-axis direction electrode and the Y-axis direction electrode, so as to diverge an opening angle of the electron beam in the X-axis direction and converge in the Y-axis direction or to converge the opening angle in the X-axis direction and diverge in the Y-axis direction.

In the case of the polarity illustrated in FIG. 9, the electron beam emitted from the point O into the XZ plane including the lateral direction of the electron emission surface receives a repulsive force from the two (−) polar electrodes in the X-axis direction and changes the beam in a direction in which the opening angle is converged, when the beam passes through the electrostatic quadrupole element 31. The electron beam receives an attractive force from the two (+) polar electrodes in the X-axis direction and changes the beam in a direction in which the opening angle is diverged, when the beam passes through the electrostatic quadrupole element 32.

The electron beam emitted from the point O into the YZ plane including the longitudinal direction of the electron emission surface receives an attractive force from the two (+) polar electrodes in the Y-axis direction and changes the beam in the direction in which the opening angle is diverged, when the beam passes through the electrostatic quadrupole element 31. The electron beam receives a repulsive force from the two (−) polar electrodes in the Y-axis direction and changes the beam in the direction in which the opening angle is converged, when the beam passes through the electrostatic quadrupole element 32.

The electron beam emitted from the electron emission surface at the same emission angle θ1 is converged at the position P on the surface 63 of the powder layer 62 at different convergence angles θ3 and 04 in the XZ plane and the YZ plane, by applying a voltage to the electrostatic quadrupole element. That is, the image of the electron emission surface is imaged on the surface 63 of the powder layer 62 at different magnifications in the XZ plane and the YZ plane.

The electrostatic quadrupole elements 31 and 32 can change the polarity and the magnitude of the voltage to be applied to the electrode, so as to change a ratio between a longitudinal direction width and a lateral direction width of the electron beam imaged on the surface 63 of the powder layer 62 in the lateral direction of the electron emission surface and the longitudinal direction of the electron emission surface. If this function is used, it is possible to change the shape of an electron beam with which the surface 63 of the powder layer 62 is irradiated, without substantially changing the current value of the electron beam.

The deformation element 30 changes the beam shape by setting voltages to the electrodes of the electrostatic quadrupole elements 31 and 32. The deformation element 30 can change the beam shape of the electron beam more stably and reproducibly than a case of changing the operating condition of the electron source 20, for example.

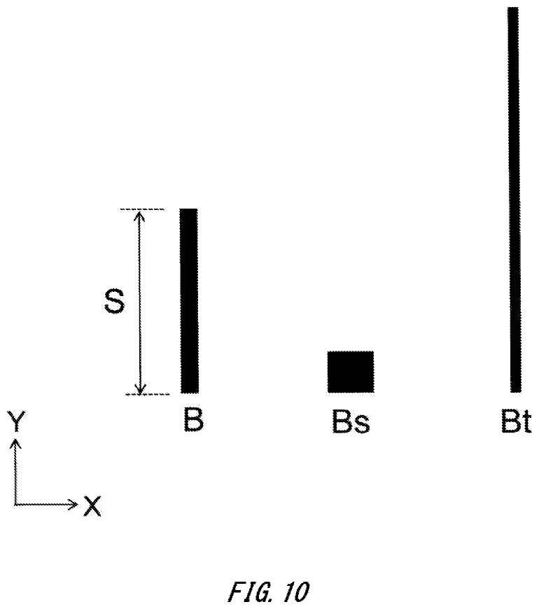

FIG. 10 illustrates an example of a shape of the electron beam for irradiating the surface 63 of the powder layer 62. An electron beam B illustrated at the left end of FIG. 10 illustrates an example of setting the electron beam having a beam width S in the longitudinal direction by applying a voltage corresponding to beam shape data B to the electrodes of the electrostatic quadrupole elements 31 and 32.

The electron beam Bs illustrated at the center of FIG. 10 illustrates an example in which the narrowed electron beam Bs in which a beam width in the longitudinal direction is reduced, and widths in the vertical and lateral directions are substantially equal to each other is set by applying a voltage corresponding to the beam shape data Bs to the electrodes of the electrostatic quadrupole elements 31 and 32. The electron beam Bt illustrated at the right end of FIG. 10 illustrates an example in which the electron beam Bt which is expanded in the longitudinal direction and in which the beam width in the longitudinal direction is expanded is set by applying a voltage corresponding to the beam shape data Bt to the electrodes of the electrostatic quadrupole elements 31 and 32.

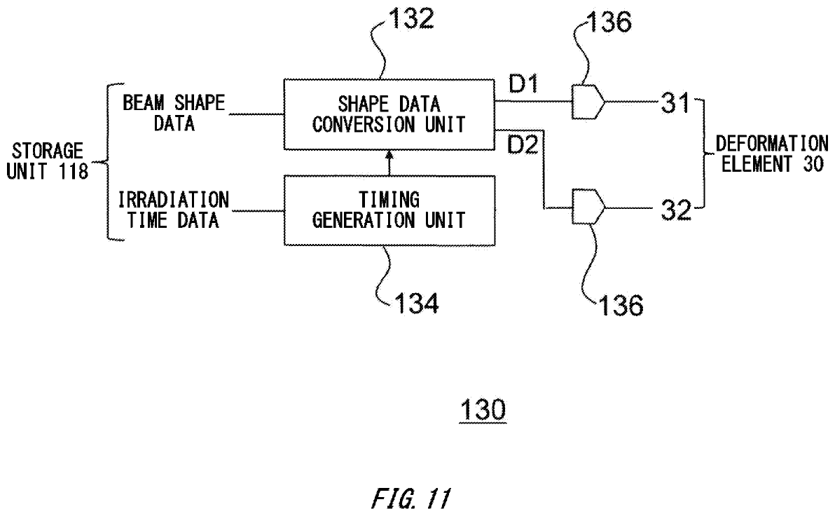

FIG. 11 illustrates a configuration example of the deformation element control unit 130 that controls the deformation element 30. A shape data conversion unit 132 receives beam shape data B which is determined by the determination unit 116 and stored in the storage unit 118, and calculates voltage data D1 and D2 to be output to the electrostatic quadrupole elements 31 and 32 of the deformation element 30.

The shape data conversion unit 132 receives the beam shape data Bs stored in the storage unit 118 and outputs voltage data D1s and D2s which are output to the electrostatic quadrupole elements 31 and 32 of the deformation element 30 and are used to form the narrowed electron beam Bs in which a beam width in the longitudinal direction is reduced, and widths in the vertical and lateral directions are substantially equal to each other.

The shape data conversion unit 132 receives the beam shape data Bt stored in the storage unit 118 and outputs voltage data D1t and D2t which are output to the electrostatic quadrupole elements 31 and 32 of the deformation element 30 and are used to form the electron beam Bt which is expanded in the longitudinal direction and in which a beam width in the longitudinal direction is expanded.

An element driving unit 136 performs digital/analog conversion of the voltage data D1 and D2 and the like output by the shape data conversion unit 132, and outputs a voltage proportional to the voltage data to the electrostatic quadrupole elements 31 and 32 of the deformation element 30. Thus, the deformation elements 30 of the first beam and the second beam set the beam shapes of the first beam and the second beam as the beam shapes indicated by the respective beam shape data.

The timing generation unit 134 receives data τab, τbc, . . . of the irradiation times corresponding to the irradiation positions, from the storage unit 118. The timing generation unit 134 generates a timing at which beam shape data converted into the voltage data D1 and D2 by the shape data conversion unit 132 is output to the element driving unit 136 and the deformation element 30, in accordance with the irradiation time. The timing generation unit 134 performs an operation similar to that of the timing generation unit 154 (see FIG. 8) of the deflection control unit 150.

The timing generation unit 134 generates a timing each time the irradiation position is switched, and outputs beam shape data. That is, even in a case where the determination unit 116 determines a different beam shape for each irradiation position, and the storage unit 118 stores different beam shape data for each irradiation position, the deformation element control unit 130 correspondingly outputs the different beam shape for each irradiation position.

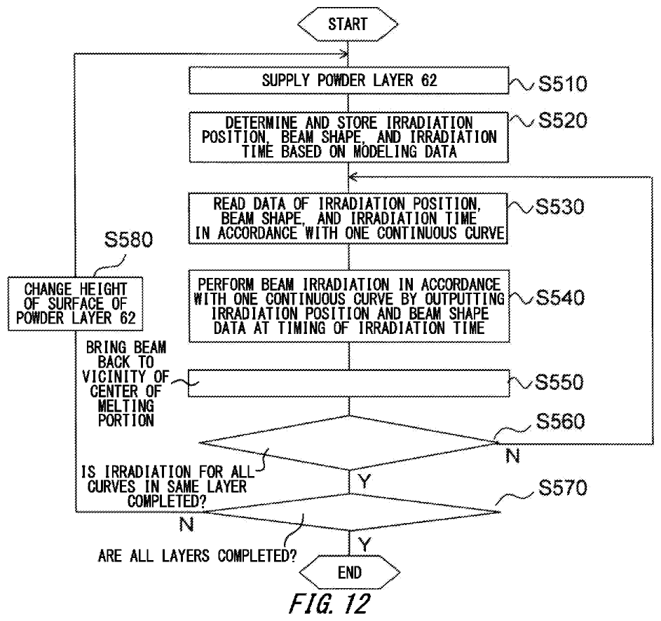

Regarding the 3D additive manufacturing device 100 having the above-described configuration example, FIG. 12 illustrates an example of an operation flow illustrating an additive manufacturing operation of the 3D additive manufacturing device 100.

If the additive manufacturing operation is started, the 3D additive manufacturing device 100 supplies a powder sample 68 from the powder supply unit 64 of the forming unit 300 and supplies a powder layer 62 flattened to be parallel to the bottom portion 72 surrounded by the side wall portion 74 (S510).

The determination unit 116 of the 3D additive manufacturing device 100 determines data of an irradiation position, a beam shape, and an irradiation time for the first beam and the second beam output from the electron beam column 200, based on modeling data accumulated in the modeling data accumulation unit 114. The determined data of the irradiation position, the beam shape, and the irradiation time is stored in the storage unit 118 (S520).

Before the surface 63 of the powder layer 62 is irradiated with the electron beam, the 3D additive manufacturing device 100 reads out the data of the irradiation positions, the beam shapes, and the irradiation times of the first beam and the second beam along a continuous curve, from the storage unit 118 (S530). The continuous curve is any of the curves e1, e2, e3, . . . , and e10 in the example of FIG. 3.

The storage unit 118 of the 3D additive manufacturing device 100 sets the read irradiation position data in the deflection data conversion unit 152 of the deflection control unit 150. The storage unit 118 sets the read beam shape data in the shape data conversion unit 132 of the deformation element control unit 130. The storage unit 118 sets the read irradiation time data in the timing generation unit 154 of the deflection control unit 150 and the timing generation unit 134 of the deformation element control unit 130.

The timing generation units 154 and 134 of the 3D additive manufacturing device 100 generate a timing signal for every irradiation time. The deflection control unit 150 outputs irradiation position data which is coordinate-transformed based on the timing signal, to the deflector 50. The deformation element control unit 130 outputs the beam shape data converted into voltage data of the deformation element 30, to the deformation element 30 based on the timing signal. Thus, the surface 63 of the powder layer 62 is irradiated with the first beam and the second beam along the continuous curve (S540).

If the irradiation with the first beam and the second beam along the continuous curve is completed, the 3D additive manufacturing device 100 brings the irradiation position of the first beam back to the vicinity of the center of a sectional layer 65 of a 3D structure 66. (S550). This is because the first beam does not melt and solidify the powder layer 62 other than the portion to be the sectional layer 65.

Step S550 can be used in a case where the 3D additive manufacturing device 100 does not have a blanking function (beam-off function) of blocking the irradiation of the surface 63 of the powder layer 62 with the electron beam. If the blanking function is provided, in Step S550, the irradiation of the powder layer 62 with the first beam may be blocked by blanking.

Then, the 3D additive manufacturing device 100 determines whether or not irradiation with the electron beam along all continuous curves in the same layer as the powder layer 62 during the irradiation with the electron beam, that is, along all the curves e1, e2, e3, . . . , and e10 in the example in FIG. 3 is completed (S560). In a case where the irradiation with the electron beam is not completed (S560; No), the 3D additive manufacturing device 100 reads data of the irradiation positions, the beam shapes, and the irradiation times of the first beam and the second beam along the next continuous curve, from the storage unit 118 (S530) and continues irradiation of the powder layer 62.

In a case where the irradiation with the electron beam is completed (S560; Yes), the 3D additive manufacturing device 100 determines whether or not melting and solidification of all powder layers 62 of the 3D structure 66 are completed (S570). In a case where melting and solidification of all the powder layers 62 are not completed (S570; No), the 3D additive manufacturing device 100 performs a feeding operation of the drive rod 84 to change the height of the surface 63 of the powder layer 62 (S580). Then, the powder sample 68 of the next powder layer 62 is supplied from the powder supply unit 64 of the forming unit 300 (S510), and the additive manufacturing operation (S520 to S560) on the next powder layer 62 is continued.

In a case where melting and solidification of all the powder layers 62 are completed (S570; Yes), the 3D additive manufacturing device 100 completes the additive manufacturing operation on the 3D structure 66.

In the above-described additive manufacturing operation, the 3D additive manufacturing device 100 simultaneously performs melt irradiation and auxiliary irradiation of the powder layer 62 with the first beam and the second beam. The 3D additive manufacturing device 100 can reduce the time for the entire additive manufacturing operation in comparison to a case where melt irradiation and auxiliary irradiation are performed separately.

In addition, the 3D additive manufacturing device 100 sets the first beam and the second beam to have the beam shapes Bs and Bt and the like, and does not significantly change the state of the electron beam, such as a beam current value or a beam size, in the middle of irradiation along the continuous curve. The 3D additive manufacturing device 100 can avoid the instability occurring in a case where the state of the electron beam is significantly changed, and eliminate a settling waiting time occurring in a case where the state of the electron beam is significantly changed.

In addition, in the above-described additive manufacturing operation, the 3D additive manufacturing device 100 performs an operation of melting and solidifying a portion of the powder layer 62 when the first beam is set to have the beam shape Bs, and additionally irradiates the powder layer 62 when the second beam is set to have the expanded electron beam Bt, in parallel to the melting and solidifying operation.

Instead of this, the 3D additive manufacturing device 100 may perform an operation of melting and solidifying a portion of the powder layer 62 when the second beam is set to have the beam shape Bs, and additionally irradiate the powder layer 62 when the first beam is set to have the expanded electron beam Bt, in parallel to the melting and solidifying operation.

Furthermore, the 3D additive manufacturing device 100 may switch roles of the first beam and the second beam in the process of melting and solidifying the powder layer 62. That is, in order to perform irradiation with the electron beam along a plurality of continuous curve on the surface 63 of the powder layer 62, for some continuous curves, the first beam and the second beam may be respectively used to perform melting irradiation and auxiliary irradiation. For other continuous curves, the second beam and the first beam may be respectively used to perform melting irradiation and auxiliary irradiation.

Although the present invention has been described using the embodiment as described above, the technical scope of the present invention is not limited to the scope described in the above embodiment. It is apparent to those skilled in the art that various changes or modifications can be added to the above embodiment. It is also apparent from the scope of the claims that modes added with such changes or modifications can also be included in the technical scope of the present invention.

It should be noted that the execution order of processes in operations, procedures, steps, and stages in the device, the system, a program, and the method shown in the claims, the specification, and the drawings is not clearly stated as “before”, “precedently” and the like, and the processes may be realized in any order unless the output in the previous process is used in the later process. With regard to the operation flow in the claims, the specification, and the drawings, even though it is described using “first”, “next”, and the like for convenience, it does not mean that it is essential to carry out in this order.

1. A 3D additive manufacturing device that forms a 3D structure by laminating sectional layers obtained by melting and solidifying a powder layer, the 3D additive manufacturing device comprising:
an electron beam column that outputs a first beam and a second beam for irradiation in parallel with the first beam;
a forming unit that accommodates raw material powder irradiated with the first beam; and
a controller that controls the electron beam column, wherein
the controller includes:
a determination unit that sets a plurality of irradiation positions of the first beam and the second beam along a plurality of loop-like lines representing a path of an electron beam with which the sectional layer is irradiated, and determines an irradiation time at each of the irradiation positions;
a storage unit that stores data of the irradiation position and the irradiation time determined by the determination unit; and
a timing generation unit that generates a timing for reading the irradiation position data from the storage unit in accordance with the irradiation time and outputting the irradiation position data to the electron beam column, and
the storage unit stores the data of the irradiation position and the irradiation time in order of irradiation with the electron beam.

2. The 3D additive manufacturing device according to claim 1, wherein
the loop-like line is represented by continuous curve consisting of arcs and line segments, and
the determination unit sets the irradiation positions along the continuous curve.

3. The 3D additive manufacturing device according to claim 2, wherein
the determination unit sets the irradiation position at a predetermined distance.

4. The 3D additive manufacturing device according to claim 2, wherein
the determination unit determines a distance between the irradiation positions along the continuous curve, in accordance with a beam shape or a beam intensity of the first beam or the second beam.

5. The 3D additive manufacturing device according to claim 2, wherein
the determination unit sets the same irradiation time for the irradiation positions set along the arcs having the same curvature radius.

6. (canceled)

7. The 3D additive manufacturing device according to claim 1, wherein
the determination unit sets the irradiation position and the irradiation time in order from the loop-like line surrounding a largest area and stores the irradiation position and the irradiation time in the storage unit.

8. The 3D additive manufacturing device according to claim 1, wherein
the electron beam column includes a plurality of deformation elements that deforms sectional shapes of the first beam and the second beam, and
the determination unit determines the sectional shapes of the first beam and the second beam along with the irradiation positions and the irradiation times of the first beam and the second beam.

9. The 3D additive manufacturing device according to claim 1, wherein
the electron beam column includes a sub-deflector that adjusts a distance between the irradiation positions of the first beam and the second beams on a surface of the powder layer.

10. An additive manufacturing method performed in a 3D additive manufacturing device that includes: an electron beam column that outputs a first beam and a second beam for irradiating a wider range than the first beam in parallel with the first beam, a forming unit that accommodates raw material powder irradiated with the first beam, and a controller that controls the electron beam column; and forms a 3D laminated structure by laminating sectional layers which are melted and solidified by irradiating a powder layer of the raw material powder with the electron beam, the additive manufacturing method comprising:
setting a plurality of irradiation positions of the first beam and the second beam along a plurality of loop-like lines representing a path of the electron beam with which the sectional layer is irradiated, determining an irradiation time at each of the irradiation positions, and storing data of the irradiation position and irradiation time in order of irradiation with the electron beam, in the controller;
outputting data of the irradiation position to the electron beam column and performing irradiation with the electron beam, at a timing generated based on the irradiation time by the controller; and
bringing the irradiation position of the electron beam back to a predetermined position on a surface of the powder layer every time irradiation with the electron beam along each of the plurality of loop-like lines is completed.

11. A 3D additive manufacturing device that forms a 3D structure by laminating sectional layers obtained by melting and solidifying a powder layer, the 3D additive manufacturing device comprising:
an electron beam column that outputs a first beam and a second beam for irradiation in parallel with the first beam;
a forming unit that accommodates raw material powder irradiated with the first beam; and
a controller that controls the electron beam column, wherein
the controller includes:
a determination unit that sets a plurality of irradiation positions of the first beam and the second beam along a plurality of loop-like lines representing a path of an electron beam with which the sectional layer is irradiated, and determines an irradiation time at each of the irradiation positions;
a storage unit that stores data of the irradiation position and the irradiation time determined by the determination unit; and
a timing generation unit that generates a timing for reading the irradiation position data from the storage unit in accordance with the irradiation time and outputting the irradiation position data to the electron beam column,
the electron beam column includes a plurality of deformation elements that deforms sectional shapes of the first beam and the second beam, and
the determination unit determines the sectional shapes of the first beam and the second beam along with the irradiation positions and the irradiation times of the first beam and the second beam.
